(19) United States
(12) Patent Application Publication
(10) Pub. No.: US 2006/0092637 A1
(43) Pub. Date: May 4, 2006

(54) LED illumination module

(76) Inventor: Peter Yeh, Tainan Hsien (TW)

Correspondence Address: HERSHKOVITZ & ASSOCIATES, 1725 I STREET NW, SUITE 300, WASHINGTON, DC, 20006, US

(21) Appl. No.: 10/975,986

(22) Filed: Oct. 29, 2004

(51) Int. Cl. F21V 21/00

(52) U.S. Cl. 362/249; 362/800

(57) ABSTRACT

An LED illumination module has a case, multiple nuts attached to inside of the case, at least one connection assembly, a bottom cover and multiple LED elements. Each connection assembly has multiple electrically conductive elements, each of which is positioned on an inside and outside of the case and in contact with the nuts, and two wire connection elements. Each LED element has an anode terminal and a cathode terminal. The two terminals of each LED element are respectively connected to two adjacent electrically conductive elements and the two wire connection elements. Therefore, the LED elements can be fixed on the case and connected to each other in series by the connection assembly and the nuts.

### BACKGROUND OF THE INVENTION

1. Field of the Invention

The present invention relates to an illumination module and more particularly to an LED illumination module that has an easy assembly function whereby production of LED illumination devices is improved.

2. Description of Related Art

Since an LED element has the advantages of relatively high light intensity, low power consumption, long term of utility etc., the LED element is popularly employed in various illumination devices. In general, one illumination device requires multiple LED elements to provide enough light intensity so how to easily assemble the multiple LED elements of a light module is an important reason for increasing the production rate of the LED illumination devices.

Therefore, the present invention provides an LED illumination module wherein multiple LED elements are assembled easily and quickly such that a production rate of the LED illumination devices is high.

### SUMMARY OF THE INVENTION

The main objective of the present invention is to provide an LED illumination module that has easy and fast assembly functions whereby the production rate of the LED illumination device is improved. The LED illumination module in accordance with the present invention mainly has a case, at least one connection assembly, a bottom cover and multiple LED elements. Each connection assembly has multiple electric conductive elements each of which extends from an inside to an outside of the case. Each LED element has an anode terminal and a cathode terminal. The two terminals of each LED element are respectively connected to two adjacent electrically conductive elements. Therefore, the LED elements can be fixed on the case and connected to each other in series by the connection assembly.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of an LED illumination module in accordance with the present invention;

FIG. 2 is a perspective view of a first embodiment of the LED illumination module in accordance with the present invention;

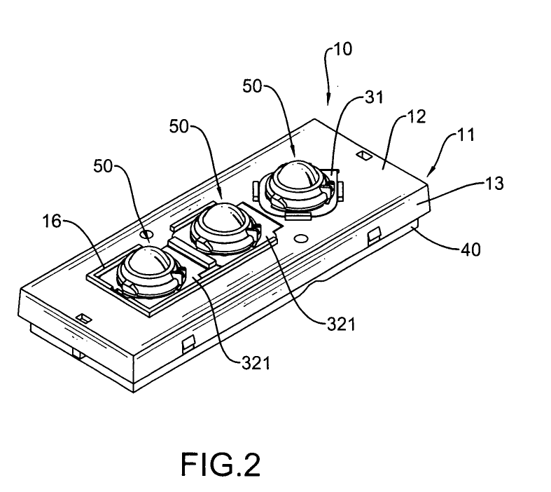

FIG. 3 is a cross sectional view of a first embodiment of the LED illumination module in accordance with the present invention;

FIG. 4 is an exploded perspective view of a second embodiment of an LED illumination module in accordance with the present invention;

FIG. 5 is a perspective view of a second embodiment of the LED illumination module in accordance with the present invention;

FIG. 6 is an exploded perspective view of a third embodiment of an LED illumination module in accordance with the present invention;

FIG. 7 is a perspective view of a third embodiment of the LED illumination module in accordance with the present invention; and

FIG. 8 is a cross sectional view of a third embodiment of the LED illumination module in accordance with the present invention.

### DETAILED DESCRIPTION OF THE PREFERRED EMBODIMENT

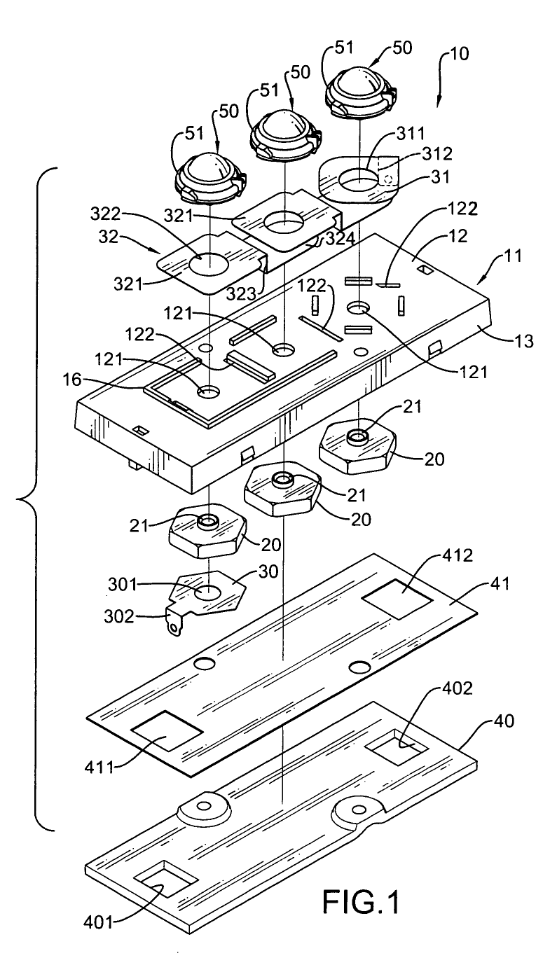

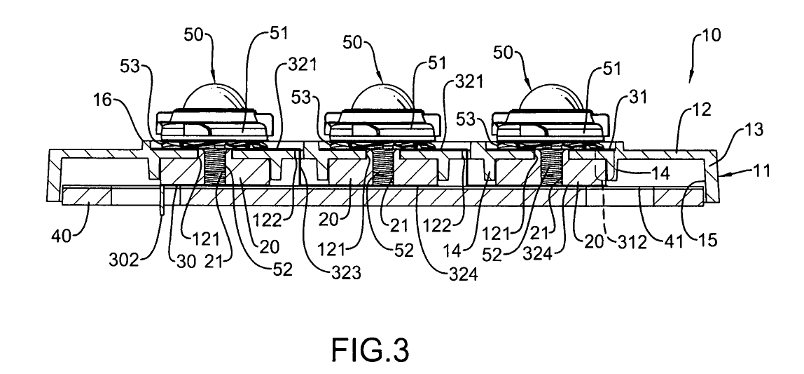

With reference to FIGS. 1 and 3, a first embodiment of an LED illumination module (10) in accordance with the present invention has a case (11), multiple nuts (20), a connection assembly, an optional electrically insulating board (41), a bottom cover (40) and multiple LED elements (50). Each LED element (50) has a bottom (51), an anode terminal (52) and a cathode terminal (53). The anode and cathode terminals (52, 53) are respectively formed on a center position and a periphery of the bottom (51), wherein the anode terminal (52) is formed as a screw and the cathode terminal (53) is formed as a detent.

The case (11) includes a top board (12), four walls (13) formed under the top board (12) and a bottom opening (15). The top board (12) has a top side, a bottom side, at least one row of multiple through holes (121), at least one optional row of through slots (122), multiple optional frames (14) formed on the bottom side of the top board (12) and multiple optional ridges (16) formed on the top side. In the first embodiment, only one row of the through holes (121) is defined in the top side of the top board (12). The multiple through holes (121) and through slots (122) are alternately defined in the top side of the top board (12). Each frame (14) is formed in the shape of the nut (20) to receive one of the nuts (20) and corresponds to the through hole (121). Therefore, a threaded hole (21) of the nut (20) is aligned to the corresponding through hole (121) when the nut (20) is received in the corresponding frame (14).

Since the first embodiment of the present invention has only one row of the through holes (121), the first embodiment has one connection assembly. The connection assembly has multiple flexible electrically conductive elements (32) and two optional wire connection elements (30, 31). A cross sectional shape of each electrically conductive element (32) is formed as a Z-shape. Each electrically conductive element (32) is composed of an upper lateral piece (321) in which a hole (322) is defined, an upright piece (323) and a lower lateral piece (324), and is positioned on the top side and bottom side of the top board (12). The upright piece (322) is connected between two opposite ends of the upper and lower lateral pieces (321, 324). Each wire connection element (30, 31) has a flat body in which a hole (301,311) is defined, and an upright portion (302, 312) extended from a periphery of the flat body.

To attach the connection assembly to the top side and bottom sides of the top board (12) according to the row of the through holes (121), the upper lateral piece (321) is positioned on the top side, the upright piece (323) is inserted into the through slot (122), and the lower lateral piece (324) is attached to the bottom side. Since the nuts (20) are attached to the bottom side first, the lower lateral piece (324) will be attached to one of the nuts (20) in the frames (14). The hole (322) of the upper later piece (321) will be aligned to the corresponding through hole (121) on the top side. Therefore, when the electrically conductive elements (32) are attached to the top board (12), one upper lateral piece (321) and the lower lateral piece (324) of adjacent electrical conductive elements (32) are overlapped together. The upper lateral piece (321) of the first electrical conductive element (32) is overlapped by the wire connection element (30), and the lower lateral piece (324) of the final electrical conductive element (32) is overlapped by the other wire connection element (31). Therefore, one wire connection element (30) is attached to the bottom side and the other wire connection element (31) is attached to the upper side. The upright portion (312) of the wire connection element (31) attached to the top side is inserted into the corresponding through slot (122), so the upright portions (302, 312) protrude from the bottom side of the top board (12).

To position the upper lateral piece (321) of each electrically conductive element (32) and one wire connection element (31) on a specific location of the top side, the ridges (16) are formed on the top side of the top board (12) according to a shape of the upper lateral piece (321) and the wire connection element (31).

The electrically insulating board (41) and the bottom cover (40) are respectively defined to two opposite openings (401,402,411,412), each of which corresponds the wire connection element (30, 31). The bottom cover (40) is mounted on the bottom opening (15) of the case (11). Since the bottom cover (40) may be made of metal material, the electrically insulating board (41) is positioned between the bottom opening (15) of the case (11) and the bottom cover (40). Therefore, the metal bottom cover (40) will not be in contact with the connection assembly and nuts (20).

To assemble the above elements of the first embodiment, firstly the nuts (20) are respectively received in the corresponding frames (14) on the bottom side of the top board (12). Then, the electric connection elements (32) and the wire connection elements (30, 31) are fixed on the top side and bottom side. The holes (322) of the upper lateral pieces (321) and the wire connection elements (30, 31) are aligned to the through holes (121) of the top board (12) and the threaded holes (21) of the nuts (20) in the frames (14). The screw (52) of each LED element (50) is inserted into the respective hole (322) and through hole (121) and then is screwed into the corresponding nut (20) until the detent (53) touches the upper lateral piece (231) and one wire connection element (31). Therefore, the LED elements (50) are electrically connected in series through the connection assembly and the nuts (20). The two openings (411, 412) (401, 402) of the electrically insulating board (41) and the bottom cover (40) are respectively corresponding to the two upright portions (302, 312) of the wire connection elements (30, 31) to allow wires to be able to connect to the wire connection elements (30, 31) through the openings (411, 41.2) (401, 402) easily. Therefore, when the wire connection elements (30, 31) are connected to DC power wires, the LED elements will light.

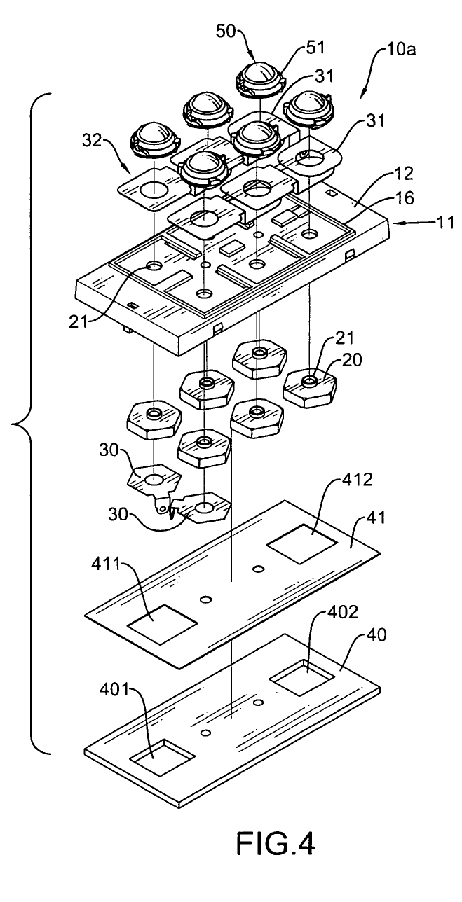

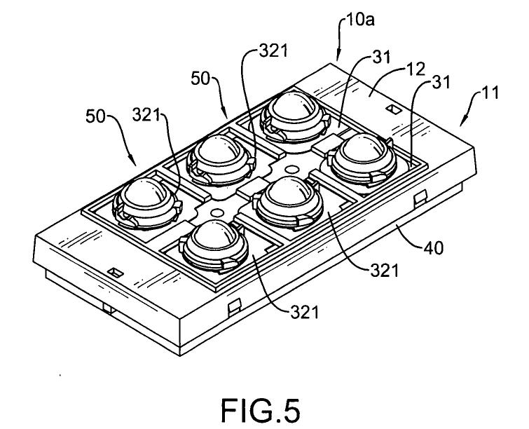

With reference to FIGS. 4 and 5, a second embodiment of the LED illumination module (10a) in accordance with the present invention is similar to the first embodiment. The second embodiment has two rows of the through holes (121) defined on the top side (12), two connection assemblies adapted to the two rows of the through holes (121). Therefore, the present invention also provides an LED illumination module including more LED elements.

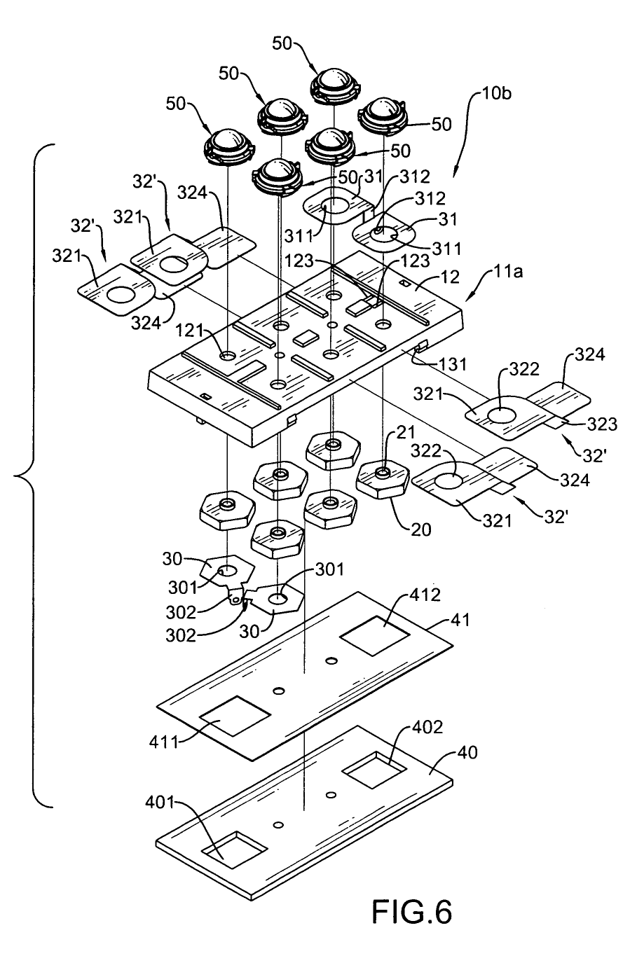

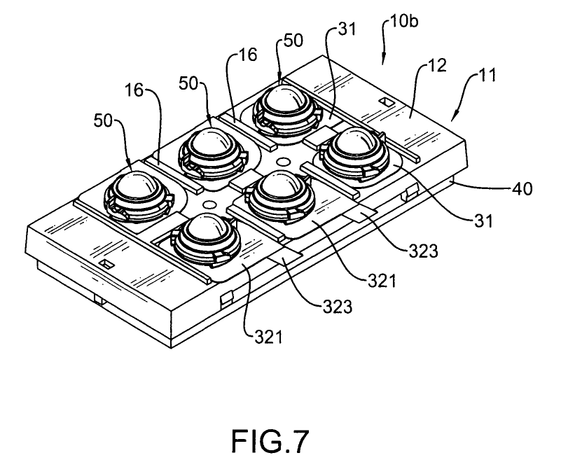

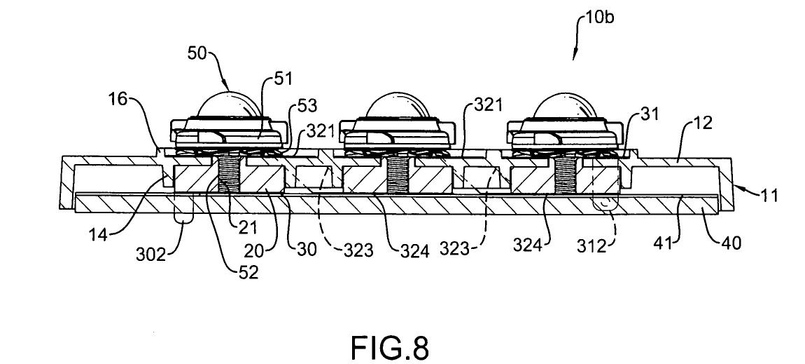

With reference to FIGS. 6 to 8, a third embodiment of the LED illumination module (10b) in accordance with the present invention is similar to the second embodiment. The connection assembly is also positioned on the top and bottom sides of the top board (12), but each electric connection element (32) of the second embodiment is changed slightly. Each electric connection element (32′) has an upper lateral piece (321) in which one hole (322) is defined, an upright piece (323) and a lower lateral piece (324). The upright piece (323) is connected between the same side ends of the upper lateral piece (321) and the lower lateral piece (324). Therefore, each electric connection element (32′) is clipped to a side of the top board (12) and the one wall (13). To reduce a length of the upright piece (323), two long openings (131) are respectively defined in an opposed two of the walls (13). Since the electric connection elements (32′) are clipped to the case (11), the LED illumination module (10b) is able to be assembled quickly.

Therefore, the third embodiment of the LED illumination module (10b) is not defined by the rows of the through slots. To allow the upright portion (312) of the wire connection element (31) to protrude to the bottom side of the top board (12), two through slots (123) are defined in the top side.

Based on the foregoing description, the present invention provides an illumination module in which it is easy to assemble the quantity of LED elements to an illumination device. Therefore, the LED illumination module has easy assembly by which the production rate of illumination devices is high.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An LED illumination module, comprising:
a case having a top board, four walls formed under the top board and a bottom opening, wherein the top board having a top side, a bottom side, at least one row of through holes;
multiple nuts mounted on the bottom side of the top board and each having a threaded hole aligned to one of the through holes of the top board;
at least one connection assembly attached to the case and having multiple electrically conductive elements and two wire connection elements, wherein each electrically conductive element with a cross sectional shape formed substantially as a Z-shape is composed of an upper lateral piece in which a hole is defined, an upright piece and a lower lateral piece, and is positioned on the top side and the bottom side of the top board, wherein each wire connection element has a flat body, an upright portion extended from a periphery of the flat body and two holes are respectively defined in the flat body and the upright portion;
a bottom cover attached to the four walls to cover the bottom opening of the case, wherein two openings are defined in the bottom cover and are aligned to the wire connection elements on the case; and
multiple LED element attached to the case, wherein each LED element has an anode terminal formed as a screw and a cathode terminal is formed as a detent, wherein the screw is screwed to one of the nuts and the detent contacts the upper lateral piece of one of the electrically conductive elements.

2. The LED illumination module as claimed in claim 1, further comprising an electrically insulating board positioned between the walls of the case and the bottom cover to insulate the bottom cover and the connection assembly.

3. The LED illumination module as claimed in claim 1, wherein the top board further comprises at least one row of the through slots, wherein one of the at least one row of the through holes and one of the at least one row of the through slots are alternately defined in the top side of the top board; and
each upper and lower lateral piece has four ends, wherein the upright piece of each electrically conductive element is connected between the opposite ends of the upper and lower lateral pieces and inserted into a corresponding one of the through slots.

4. The LED illumination module as claimed in claim 3, wherein one of the wire connection elements, the upright portion of which is inserted to the corresponding through slot, is attached to the top side to the top board.

5. The LED illumination module as claimed in claim 1, wherein each upper and lower lateral piece has four ends, wherein the upright piece of each electrically conductive element is connected between the two same side ends of the upper and lower lateral pieces and inserted into a corresponding one of the through slots.

6. The LED illumination module as claimed in claim 1, wherein the top side is defined with one through slot into which the upright portion of one of the wire connection elements is inserted.

7. The LED illumination module as claimed in claim 5, wherein two of the four walls are respectively further defined with one long opening.

8. The LED illumination module as claimed in claim 3, wherein the case has multiple frames formed on the bottom side of the case to receive the nuts.

9. The LED illumination module as claimed in claim 3, wherein the case has multiple ridges formed on the top side according to a shape of the upper lateral pieces and the wire connection elements.

10. The LED illumination module as claimed in claim 5, wherein the case has multiple frames formed on the bottom side of the case to receive the nuts.

11. The LED illumination module as claimed in claim 5, wherein the case has multiple ridges formed on the top side according to a shape of the upper lateral pieces and the wire connection elements.
